(19) United States
(12) Patent Application Publication
(10) Pub. No.: US 2013/0046697 A1
(43) Pub. Date: Feb. 21, 2013

(54) Using Mobile Device to Prevent Theft of User Credentials

(71) Applicant: Norman Schibuk, Merrick, NY (US)

(72) Inventor: Norman Schibuk, Merrick, NY (US)

(73) Assignee: SURIDX, INC., Wellesley, MA (US)

(21) Appl. No.: 13/422,747

(22) Filed: Mar. 16, 2012

Related U.S. Application Data
(60) Provisional application No. 61/453,911, filed on Mar. 17, 2011.

(51) Int. Cl. G06Q 20/36; G06Q 20/32; G06Q 20/40; G06Q 20/20

(52) U.S. Cl. 705/67

(57) ABSTRACT

Systems and methods are provided to prevent unauthorized credit and debit transactions. A system creates a transactional, or one-time-use PIN in response to a request from a mobile device, such as a smartphone or tablet computer, belonging to an authorized user. This PIN is securely transmitted to the mobile device, and used in combination with a credit or debit account number to complete the transaction. The user is determined to be authorized by the fact that they are able to access an application on the mobile device that sends the request. The application itself may be protected using a non-changing PIN.

### CROSS-REFERENCE TO RELATED APPLICATION

This application claims the benefit of U.S. Provisional Application No. 61/453,911, filed Mar. 17, 2011, the contents of which are incorporated herein by reference in their entirety.

### TECHNICAL FIELD

The present invention relates to preventing identity theft, and more particularly to the use of a mobile device and a one-time PIN to prevent harm arising from credit and debit card skimming.

### BACKGROUND ART

Skimming is commonly defined as the theft of credit or debit card information used in an otherwise legitimate transaction. For example, thieves may skim card numbers by installing credit card readers and/or false keyboards and cameras in an ATM machine. The theft occurs when an unsuspecting user inserts a credit or debit card into the compromised reader, which copies the information on the card. The user then enters their personal identification number (PIN) on the ATM keypad. The PIN is captured by camera, or for ATMs with out touch screens, by an overlay device installed over or in the ATM keypad. Using a magnetic card writer, a commonly available device, the thieves duplicate the information from the card's magnetic stripe onto a dummy card. They then use the dummy card and stolen PIN in an ATM machine (or other point-of-sale device) to empty the user's bank account or make illegal purchases. Skimmers have targeted many ATMs, even some installed inside bank premises.

Skimming represents an ongoing problem that costs financial institutions fees in the form of charge backs, fraud detection programs, and fraudulent purchase refund guarantees to consumers, among others. While some groups in Europe have installed smartcards into their plastic credit and debit cards to prevent card duplication, this does not prevent a thief who skims a PIN from stealing the physical card (perhaps, by waiting around the corner from the ATM machine). The thief will still be able to drain the user's bank account if he acts quickly, before the user has an opportunity to report that the card has been stolen.

### SUMMARY OF ILLUSTRATED EMBODIMENTS

A principle problem with skimming is that the authentication factors used to complete the transaction, namely the account number and PIN, do not change. To solve this problem, various embodiments of the invention create a “transactional” PIN. The transactional PIN is useful only for a single transaction, and may also be useful for only a limited time, such as five minutes. The PIN is created in response to a request made by an application that is downloaded onto a mobile device, such as a smartphone or a tablet computer. Thus, the burden of authentication is transferred from the ATM or other transactional device to the user's mobile device. Authentication is guaranteed because the individual must first authenticate to their mobile device (and to the application thereon). The credit or debit card then becomes merely a physical token that may be combined with the authentication factors used by the individual to log in to their mobile device to provide complete authentication for the transaction.

Therefore, in one embodiment of the present invention there is provided a method for authenticating a physical token as part of initiation of a commercial credit or debit transaction. The physical token may be a credit card or debit card having a magnetic stripe in which are stored data pertaining to a credit account or a debit account. The transaction is implemented using a transactional device, such as an ATM or point-of-sale device having a magnetic stripe reader.

The method includes a number of processes. First, the method includes receiving, in a computer system from a mobile device, a request to initiate the transaction, the request including data pertinent to the transaction. The computer system may be located remotely, on the premises of a financial institution, or it may be part of the transactional device itself. The mobile device may be a smartphone, a personal digital assistant, or a laptop computer, among other devices. The request data optionally may include data identifying a party seeking to initiate the transaction, a withdrawal amount, a good or service that is the subject of the transaction, or a sales price.

Next, the method calls for generating a transactional PIN in the computer system, encrypting the transactional PIN using an encryption key uniquely associated with the mobile device, and transmitting the encrypted transactional PIN to the mobile device. Finally, the method calls for receiving from the transactional device the unencrypted transactional PIN and data pertaining to the physical token, before a pre-specified expiration time. The pre-specified expiration time may be, for example, no greater than 60 seconds after receiving the request. The short-range wireless network may include, among other things, a near-field communications network or a cellular telephone network. If the computer system is part of the transactional device, it may use the short-range wireless network to transmit the encrypted transactional PIN to the mobile device.

In this way, receiving the unencrypted transactional PIN indicates that the encrypted transactional PIN was decrypted by the mobile device using a decryption key uniquely associated with the mobile device. Further, receiving the unencrypted transactional PIN and the physical token before the pre-specified expiration time indicates that the same individual possesses the unencrypted PIN and the physical token, so as to authenticate the physical token.

ATMs that use embodiments of this invention can prevent the fraudulent transactions associated with skimming. Even if the ATM is compromised via skimming, and a consumer's information is stolen, the thieves cannot get a usable PIN for future use. Any reuse of the PIN with that card (or a dummy card) will cause the ATM to alert the financial institution to the presence of a possible skimmer. Since the PIN is unique, the location of the skimmer can now be determined. Along with a timestamp and video footage, the image of the perpetrator can be recovered, and sent to law enforcement authorities.

Advantageously, the invention may be embodied without any change to existing ATM hardware. Also, ATM transactions work unchanged, and no slow down is experienced by the customer. A software change is required, but only at the financial institution. On the customer's end, a user only has to install a new application on their mobile device (such as a smartphone). Banks already provide small screen-enabled websites and smartphone applications for mobile devices. It is contemplated that this invention may be embodied as another such application. Further, such a system may be used with all types of credit or debit card transactions, not just those at ATMs.

A computer program product and a mobile device for use with this method are also contemplated.

### BRIEF DESCRIPTION OF THE DRAWINGS

The foregoing features will be more readily understood by reference to the following detailed description, taken with reference to the accompanying drawings, in which:

FIG. 1 is a block diagram showing logical processes for registering a mobile device with a financial institution to prepare for use in a transaction in accordance of an embodiment of the present invention;

FIG. 2 is a block diagram showing logical processes in accordance with an embodiment of the present invention for obtaining a PIN for use in a particular transaction; and

FIG. 3 is a block diagram showing logical processes in accordance with an embodiment of the present invention for using a PIN in a particular transaction.

### DETAILED DESCRIPTION OF SPECIFIC EMBODIMENTS

Definitions. As used in this description and the accompanying claims, the following terms shall have the meanings indicated, unless the context otherwise requires:

A “mobile device” is any device, such as a smartphone, personal digital assistant, personal computer, laptop, tablet computer or other device that may perform cryptographic operations and communicate on a short-range wireless data network, such as wireless telephone or near-field communications (NFC) network.

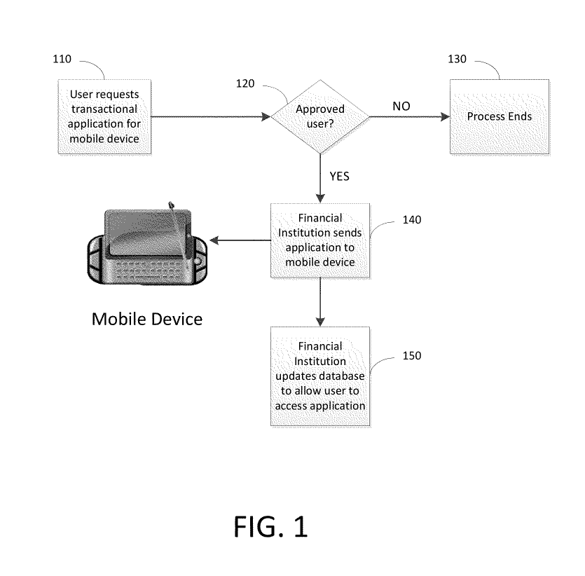

FIG. 1 is a block diagram showing logical processes for registering a mobile device with a financial institution to prepare for use in a transaction in accordance of an embodiment of the present invention. In process 110, a user requests a transactional software application from her financial institution, for use on her mobile device. The concept of such applications generally is well known in the art, but this particular application is new in that it allows the user to receive and process a transactional PIN. In process 120, the financial institution verifies that the user is authorized to download the application. If the user is not authorized, then the method ends in process 130, which may include notifying an authorized user of an attempted, unauthorized transaction. If the user is authorized, then the method continues in process 140, in which the financial institution sends the software application to the user's mobile device as indicated. In process 150, the financial institution updates a database to indicate that the user has downloaded the application and is allowed to access and use the application for commercial transactions.

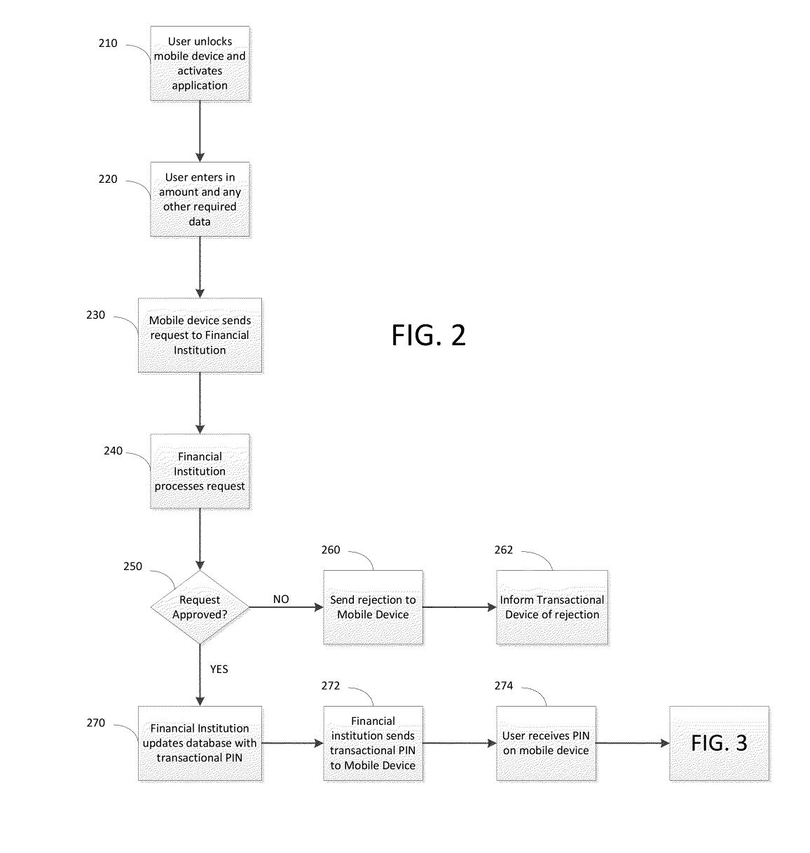

FIG. 2 is a block diagram showing logical processes in accordance with an embodiment of the present invention for obtaining a PIN for use in a particular transaction. For example, our user may wish to withdraw money from an ATM, or engage in a purchase at a retail establishment. If so, she would begin in process 210 by unlocking her mobile device and activating the application. Techniques for unlocking mobile devices are known in the art, and generally require entry of a password, biometric data such as a fingerprint, or other information unique to the owner or user. Activating the application may include selecting an icon on a menu screen, for example, or entering a secondary password. The secondary password may be a fixed PIN assigned by the financial institution. In process 220, our user may enter into her mobile device a withdrawal or sales amount and any other data required by the transaction. In one embodiment, the mobile device uses location awareness (for example, the location of the device as determined by a GPS device) to transmit its current location or the location of the nearest ATM. In process 230, her mobile device sends a request containing these data to her financial institution for approval. Transmission of the request may be done using a data communications network known in the art, such as a cellular telephone data network. In process 240, a computer system of the financial institution processes the request to determine whether to approve the request. To make this determination, the financial institution may use the user's available balance, whether her credit card has expired, whether a fraud hold has been placed on her account, and any other information according to techniques known in the art.

In process 250, the computer system makes a determination whether the request is approved. If not, it sends a rejection to the user's mobile device in process 260 using the data communications network. In a typical embodiment, a reason will be sent as well, and this rejection will manifest as an error screen in the transactional software application. In addition, if the request included location data, the financial institution may inform any nearby or indicated transactional device of the rejection in process 262, thereby preventing the user from transacting using these devices.

If the request is approved, in process 270 the financial institution updates its database with a transactional PIN. This PIN may be used only for a single transaction, or series of related transactions, and may not be reused. It is therefore generated, as part of process 270, as a random or pseudo-random number using techniques known in the art. It may also be given an expiration time, so that it may not be used after that time. This time is pre-specified; that is, it is specified in advance of the actual transaction.

Once the transactional PIN has been stored in the database, in process 272 the computer system sends the PIN to the mobile device. This may be done using SMS or other texting system, as known in the art. Finally, the user receives the PIN on her mobile device in process 274. The transactional software application decrypts this PIN, if necessary, and stores it for later use. The actual transaction may not occur for some time, but it must commence before the expiration of the pre-specified expiration time. This delay between preparation and execution is useful, for example, if a user wishes to obtain her PIN while standing in line at an ATM or in a check-out line at a retailer. In such situations, the pre-specified expiration time may be very soon, for example five minutes in the future. This short expiration time advantageously prevents PIN collisions, as well as preventing multiple uses of the same PIN at later times.

In some embodiments, the PIN is encrypted using an encryption key that is uniquely associated with the mobile device before it is transmitted to the mobile device in process 272. For example, the transactional software application may have established an asymmetric encryption/decryption key pair, storing the decryption key locally (and securely, for example in a hardware smartcard) on the mobile device and transmitting the encryption key to the financial institution. In such a situation, the indicated encryption is performed using the transmitted encryption key, which may be stored in the financial institution's database. Or the application itself may have been generated by the financial institution with a decryption key as part of its program code, with the financial institution storing a corresponding encryption key. In the latter case, no cryptographic keys need be transmitted over a network at all.

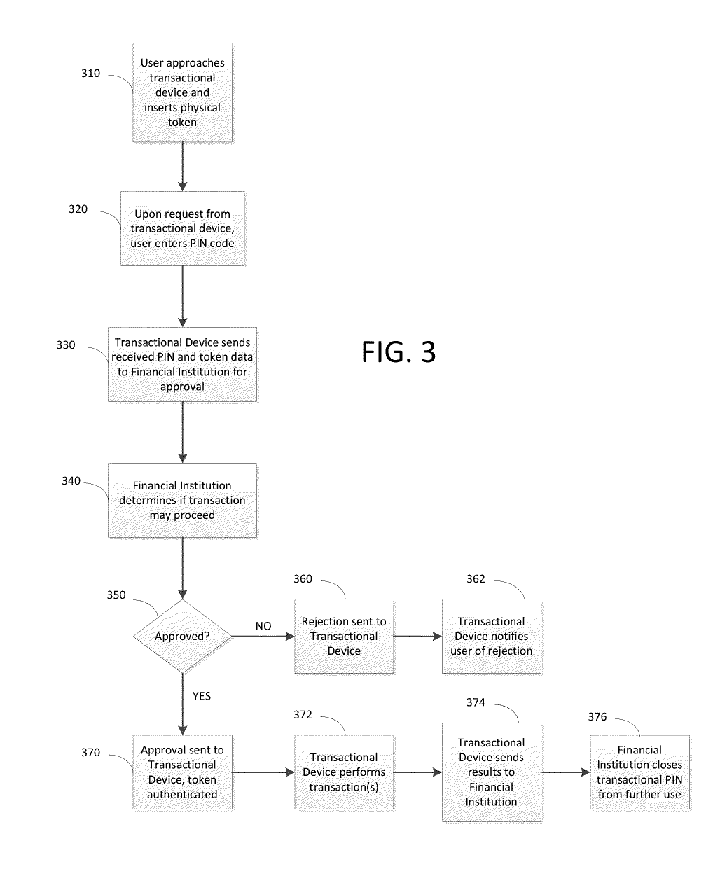

FIG. 3 is a block diagram showing logical processes in accordance with an embodiment of the present invention for using a PIN in a particular transaction. In process 310, the user approaches the transactional device, and inserts her physical token. For example, this may include her inserting a debit card (physical token) into an ATM machine (transactional device). In process 320, the user enters her transactional PIN code upon request from the transactional device. In some embodiments, the user keys in the received PIN. However, in other embodiments, the PIN request itself may be made to the mobile device using a short-range wireless network, such as a near-field communications network or a wireless cellular telephone network. Thus, in some embodiments, the transactional device includes a NFC transceiver or a low-cost picocell wireless transceiver. Entry of the transactional PIN in this embodiment need not be by touch pad; the local wireless network is sufficient. Thus, entry of the PIN may be accomplished by holding the mobile device up to the transactional device. In some embodiments, the mobile device will be already in range of the transceiver, and may transmit the PIN directly and automatically, without mechanical entry at all.

In process 330, the transactional device sends the received PIN and token data to the financial institution for approval of the transaction. In process 340, the financial institution determines if the transaction may proceed. This determination includes matching the transactional PIN to the token data (e.g., credit card number) of the user. Typically, it will do so by consulting the database, in which are stored the transactional PIN, the expiration time, and the user's account information. The financial institution may use other information, such as her current balance, to make this determination.

In process 350, the computer system determines whether the transaction is allowed to proceed. If not, in process 360 a rejection is sent to the transactional device. The transactional device then notifies the user of the rejection in process 362. For example, an ATM may show the user a “not enough cash” screen. If the rejection is caused by a mismatch between the PIN and the physical token, then the financial institution may infer that fraud is taking place. In such situations, the user may be given a false reason for rejection to avoid arousing suspicion. Simultaneously, the date, time, and location of the failed transaction may be stored by the financial institution for later use. In an ATM embodiment, this data may be correlated to security footage taken from a built-in camera at that location to obtain a picture of the person entering the bad PIN. In some cases, an image of the user can be compared against a known image of the account holder, and if the two do not match, the financial institution may give law enforcement the captured image.

If the transaction is permitted, in process 370 an approval message is sent to the transactional device and the physical token is thereby finally authenticated. Thus, the user has been authenticated, and is now authorized to perform transactions using the transactional device. In process 372, the transactional device performs one or more transactions with the user. In process 374, the transactional device sends the results of these transactions to the financial institution for recordation and post-transaction processing as is known in the art. Finally, in process 376, the financial institution invalidates the transactional PIN, preventing it from being further used. In some embodiments, this last process is performed even if the pre-specified time has not yet passed, forcing the user to activate her transactional software application yet again to obtain a new transactional PIN. This extra process is taken because the user has concluded the transaction for which the first PIN was assigned—even if she has made a mistake and needs to correct it by re-authenticating, the system may consider this a new transaction for which a new transactional PIN is required.

The embodiments of the invention described above are intended to be merely exemplary; numerous variations and modifications will be apparent to those skilled in the art. All such variations and modifications are intended to be within the scope of the present invention as defined in any appended claims.

It should be noted that the logic flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

What is claimed is:

1. A method for authenticating a physical token as part of initiation of a commercial credit or debit transaction that is implemented using a transactional device, the method comprising:
receiving, in a computer system from a mobile device, a request to initiate the transaction, the request including data pertinent to the transaction;
generating a transactional PIN in the computer system;
encrypting the transactional PIN using an encryption key uniquely associated with the mobile device;
transmitting the encrypted transactional PIN to the mobile device; and
receiving, from the transactional device, the unencrypted transactional PIN and data pertaining to the physical token, before a pre-specified expiration time, so that receiving the unencrypted transactional PIN indicates that the encrypted transactional PIN was decrypted by the mobile device using a decryption key uniquely associated with the mobile device, and receiving the unencrypted transactional PIN and the physical token before the pre-specified expiration time indicates that the same individual possesses the unencrypted PIN and the physical token, so as to authenticate the physical token.

2. The method of claim 1, wherein the physical token is a credit card or a debit card.

3. The method of claim 1, wherein the mobile device is a smartphone, personal digital assistant, personal computer, laptop, or a tablet computer.

4. The method of claim 1, wherein the data pertinent to the transaction include at least one of data identifying a party seeking to initiate the transaction, a withdrawal amount, a good or service that is the subject of the transaction, and a sales price.

5. The method of claim 1, further comprising receiving the unencrypted PIN in the transactional device using a short-range wireless network.

6. The method of claim 5, wherein the short-range wireless network includes at least one of a near-field communications network and a cellular telephone network.

7. The method of claim 1, wherein the transactional device includes a magnetic stripe reader, and the physical token includes a magnetic stripe in which are stored data pertaining to a credit account or a debit account.

8. The method of claim 7, wherein the transactional device is an ATM or a retail point-of-sale device.

9. The method of claim 1, wherein the pre-specified expiration time is no greater than five minutes after receiving the request.

10. A tangible medium on which is stored non-transient computer program code for authenticating a physical token as part of initiation of a commercial credit or debit transaction that is implemented using a transactional device, the medium comprising:
program code for receiving, in a computer system from a mobile device, a request to initiate the transaction, the request including data pertinent to the transaction;
program code for generating a transactional PIN in the computer system;
program code for encrypting the transactional PIN using an encryption key uniquely associated with the mobile device;
program code for transmitting the encrypted transactional PIN to the mobile device; and
program code for receiving, from the transactional device, the unencrypted transactional PIN and data relating to the physical token, before a pre-specified expiration time,
so that receiving the unencrypted transactional PIN indicates that the encrypted transactional PIN was decrypted by the mobile device using a decryption key uniquely associated with the mobile device, and receiving the unencrypted transactional PIN and the physical token before the pre-specified expiration time indicates that the same individual possesses the unencrypted PIN and the physical token, so as to authenticate the physical token.

11. The medium of claim 10, wherein the physical token is a credit card or a debit card.

12. The medium of claim 10, wherein the mobile device is a smartphone, personal digital assistant, personal computer, laptop, or a tablet computer.

13. The medium of claim 10, wherein the data pertinent to the transaction include at least one of data identifying a party seeking to initiate the transaction, a withdrawal amount, a good or service that is the subject of the transaction, and a sales price.

14. The medium of claim 10, wherein the transactional device includes a magnetic stripe reader, and the physical token includes a magnetic stripe in which are stored data pertaining to a credit account or a debit account.

15. The medium of claim 14, wherein the transactional device is an ATM or a retail point-of-sale device.

16. The medium of claim 10, wherein the pre-specified expiration time is no greater than five minutes after receiving the request.

17. A mobile device comprising:
a computing processor;
an input device;
a short-range wireless network transmitter; and
a hardware memory in which is stored a decryption key uniquely associated with an individual and a software application, the application being executable using the computing processor only after entry into the input device of authentication data of the individual, the application being configured to:
receive, from a financial institution, an encrypted transactional PIN;
decrypt the transactional PIN using the stored decryption key; and
transmit, to a transactional device using the short-range wireless network transmitter, the decrypted transactional PIN, thereby causing the transactional device to execute a financial transaction.

18. The mobile device of claim 17, wherein the computing processor, input device, network transmitter, and memory collectively comprise a smartphone, personal digital assistant, personal computer, laptop, or a tablet computer.
